(19) United States
(12) Patent Application Publication
(10) Pub. No.: US 2017/0280092 A1
(43) Pub. Date: Sep. 28, 2017

(54) METHOD AND ELECTRONIC DEVICE FOR PLAYING QUALITY ADJUSTMENT IN MULTI-WINDOW VIDEO PLAYING

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Xianjin CAO, Beijing (CN)

(21) Appl. No.: 15/246,037

(22) Filed: Aug. 24, 2016

Related U.S. Application Data
(63) Continuation of application No. PCT/CN2016/089434, filed on Jul. 8, 2016.

(30) Foreign Application Priority Data
Mar. 22, 2016 (CN) 201610166686.0

(51) Int. Cl. H04N 5/445; G11B 27/34; H04L 29/06

(52) U.S. Cl. CPC H04N 5/44591; H04L 65/601; H04L 65/608; G11B 27/34; G06F 3/0481

(57) ABSTRACT

A method for playing quality adjustment in multi-window video playing is disclosed. The method includes: at an electronic device, presetting the number of video playing windows and corresponding playing qualities according to performance of the electronic device, wherein the video playing windows includes one master window and one or more slave windows; and all the slave windows are set to have the same playing quality, and the master window has a playing quality higher than that of the slave windows; receiving a focus determining instruction to determine a focus window indicated by the focus determining instruction as the master window and other windows as the slave windows; and playing a video file in the master window according to the preset playing quality of the master window, and playing the video file in the slave windows according to the preset playing quality of the slave windows.

### CROSS REFERENCE TO RELATED APPLICATIONS

The present disclosure is a continuation application of PCT International patent application No. PCT/CN2016/089434, filed on Jul. 8, 2016, which claims priority to Chinese Patent Application No. 201610166686.0, filed with the Chinese Patent Office on Mar. 22, 2016, both of which are herein incorporated by reference in their entireties.

### TECHNICAL FIELD

The present disclosure relates to the technical field of video playing, and particularly, to a method and an electronic device for playing quality adjustment in multi-window video playing.

### BACKGROUND

With the rapid development of the multimedia technology, better video watching experiences on terminals are required by users. This not only proposes requirements on the playing effect, smoothness or the like of the video, and the playing interface of videos is not limited to that one playing window can only play one video file, i.e., in the interface of many video playing terminals current available, a multi-window video playing manner in which several video files can be played at the same time has emerged. Taking TVs as an example, the TVs current available not only can set several windows to play the conventional TV programs at the same time, but can also be connected to the internet to play online videos.

### SUMMARY

A method for playing quality adjustment in multi-window video playing is provided in an embodiment of the present disclosure. The method includes: at an electronic device, presetting the number of video playing windows and corresponding playing qualities according to performance of the electronic device, wherein the video playing windows comprises one master window and at least one slave window; and all of the at least one slave window are set to have the same playing quality, and the master window has a playing quality higher than that of the at least one slave window; receiving a focus determining instruction to determine a focus window indicated by the focus determining instruction as the master window and other windows as the at least one slave window; and playing a video file in the master window according to the preset playing quality of the master window, and playing the video file in the at least one slave window according to the preset playing quality of the at least one slave window.

An electronic device is provided in another embodiment of the present disclosure. The electronic device includes at least one processor and a memory. The memory is communicably connected with the at least one processor for storing instructions executable by the at least one processor. wherein execution of the instructions by the at least one processor causes the at least one processor to:

preset the number of video playing windows and corresponding playing qualities according to performance of the electronic device, wherein the video playing windows comprises one master window and at least one slave window; and all of the at least one slave window are set to have the same playing quality, and the master window has a playing quality higher than that of the at least one slave window;

receive a focus determining instruction to determine a focus window indicated by the focus determining instruction as the master window and other windows as the at least one slave window; and

play a video file in the master window according to the preset playing quality of the master window, and play the video file in the at least one slave window according to the preset playing quality of the at least one slave window.

A non-transitory computer-readable storage medium is provided in still another embodiment of the present disclosure. The non-transitory computer-readable storage medium stores executable instructions, wherein when executed by an electronic device, causes the electronic device to:

preset the number of video playing windows and corresponding playing qualities according to performance of the electronic device, wherein the video playing windows comprises one master window and at least one slave window; and all of the at least one slave window are set to have the same playing quality, and the master window has a playing quality higher than that of the at least one slave window;

receive a focus determining instruction to determine a focus window indicated by the focus determining instruction as the master window and other windows as the at least one slave window; and

play a video file in the master window according to the preset playing quality of the master window, and play the video file in the at least one slave window according to the preset playing quality of the at least one slave window.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart diagram of an embodiment of a method for playing quality adjustment in multi-window video playing according to the present disclosure.

FIG. 2 is a flowchart diagram of another embodiment of the method for playing quality adjustment in multi-window video playing according to the present disclosure.

FIG. 3 is a schematic structural diagram of an embodiment of an apparatus for playing quality adjustment in multi-window video playing according to the present disclosure.

FIG. 4 is a schematic structural diagram of a window setting module of the apparatus of FIG. 3.

FIG. 5 is a schematic structural diagram of another embodiment of an apparatus for playing quality adjustment in multi-window video playing according to the present disclosure.

FIG. 6 is a schematic structural diagram of an embodiment of a video playing terminal according to the present disclosure.

### DETAILED DESCRIPTION

To make the objective, technical solutions and advantages of the present disclosure clearer, the present disclosure will be further detailed with reference to embodiments thereof and the attached drawings.

It shall be appreciated that, all expressions employing terms such as “the first” and “the second” as used in the embodiments of the present disclosure are intended to distinguish two entities or parameters which have the same name but actually are different from each other. Therefore, the terms such as “the first” and “the second” are only for convenience of description and should not be construed as being limiting to the embodiments of the present disclosure, and this will not be further described for the subsequent embodiments.

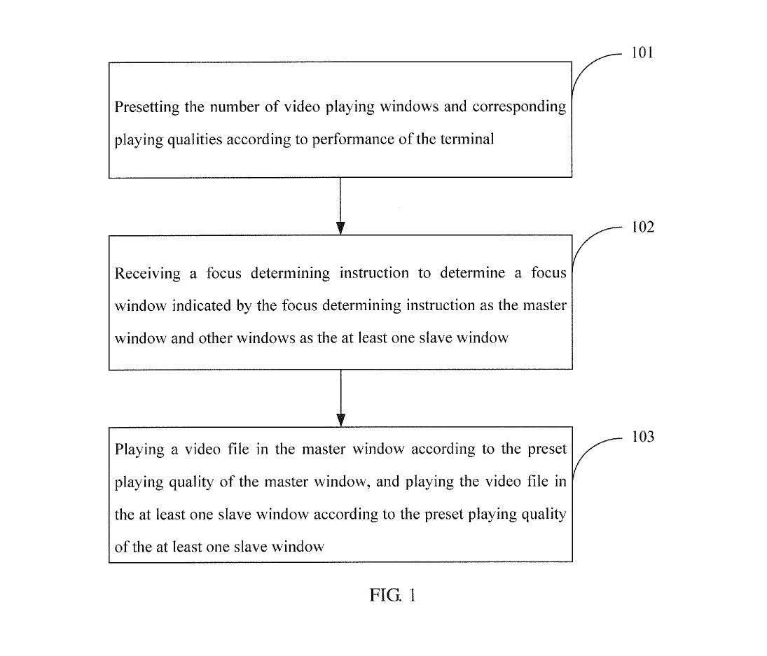

FIG. 1 is a flowchart diagram of an embodiment of a method for playing quality adjustment in multi-window video playing according to the present disclosure. The method for playing quality adjustment in multi-window video playing is applied to the multi-window video playing process in playing terminals such as mobile phones, computers, TVs, and network set-top boxes. The method can adjust the playing quality of the video according to the performance of the terminal, thereby finally providing users of the terminal better multi-window video playing experiences. The method includes the following steps.

In Step 101: presetting the number of video playing windows and corresponding playing qualities according to performance of the terminal, wherein the video playing windows include one master window and at least one slave window; and all of the at least one slave window are set to have the same playing quality, and the master window has a playing quality higher than that of the at least one slave window.

The performance of the terminal refers to system resources consumed by the terminal for video playing, e.g., the internal memory of a mobile phone, the CPU performance of a computer, relevant configurations of an intelligent TV, or the like.

in Step 102: receiving a focus determining instruction to determine a focus window indicated by the focus determining instruction as the master window and other windows as the at least one slave window.

The focus determining instruction refers to an operation command for determining the playing master window when the user is operating the terminal, e.g., the infrared sensing in the TV, the touch control in the mobile phone, the selecting operation of the mouse in the computer, or the like. The user determines the master window for video playing according to the focus determining instruction.

In Step 103: playing a video file in the master window according to the preset playing quality of the master window, and playing the video file in the at least one slave window according to the preset playing quality of the at least one slave window.

After the master window for video playing is determined, the corresponding video file is played in the determined master window according to the preset video playing quality, and other corresponding video files are played in the slave windows. The playing quality refers to the video watching effect for the user of the terminal when the video is played, e.g., the definition of the video image, the code rate of the video, the smoothness of video playing, and the size of the playing window or the like.

As can be known from the above embodiments, the method for playing quality adjustment in multi-window video playing presets the number of playing windows and corresponding playing qualities according to playing performance of the terminal before the videos are played so that the videos can be played subsequently according to the preset playing qualities during the multi-window video playing. In this way, the smoothness and stability of multi-window video playing can be ensured, and moreover, better video playing experiences are provided for the users by relatively improving the playing quality of the master window.

In some exemplary embodiments, the playing quality includes a code rate of the video, and the larger the code rate of the video is, the higher the playing quality of the video will be.

The step 101 of presetting the number of video playing windows and corresponding playing qualities according to performance of the terminal includes:

presetting a maximum code rate threshold that the terminal is able to withstand according to data transmission performance and decoding performance of the terminal; and

setting a code rate of the master window and a code rate of the at least one slave window according to the preset number of video playing windows in such a way that the sum of the code rates of all the video playing windows does not exceed the code rate threshold.

The performance of the terminal refers to the data transmission performance and decoding performance of the terminal, the data transmission performance includes the speed of obtaining and calling video files locally or from the network termination, and the decoding performance includes the speed of decoding the video files by the terminal and the corresponding decoding quality or the like. Here, the maximum code rate threshold is an upper threshold summarizing the aforesaid performance of the terminal. That is, when the code rates of all the video files that need to be processed and played by the terminal exceeds the code rate threshold, the operating efficiency of the terminal will be compromised and thus video playing discontinuity may occur. Therefore, the sum of the code rates of all the video playing windows is set not to exceed the code rate threshold, and in this way, the smoothness and the stability of the multi-window video playing are greatly ensured.

In some exemplary embodiments, the step of setting a code rate of the master window and a code rate of the at least one slave window according to the preset number of video playing windows includes:

obtaining all code rates corresponding to videos that can be obtained by the terminal, choosing two different code rates from all the code rates, and taking a greater one of the two different code rates as the code rate of the master window and a smaller one as the code rate of the slave window;

calculating a sum of the code rates of the master window and all the at least one slave window, and determining whether the sum of the code rates of all windows is greater than the code rate threshold, and if the determination result is yes, then two different code rates are re-chosen to make the determination and, otherwise, the two different code rates are used as a preset code rate combination to assign the greater one of the two different code rates to the master window and the smaller one to the at least one slave window.

All the code rates corresponding to the videos refer to the code rates corresponding to all videos that can be obtained locally or from the network when the terminal is playing the videos. In the step of determining whether the sum of the code rates of all windows is greater than the code rate threshold, the code rates of the slave windows are calculated by multiplying the number of the slave windows. For example, the preset code rate threshold is 100, the terminal is set with one master window and three slave windows, and the code rates corresponding to the videos that can be obtained by the terminal are respectively 10, 20, 30, 40 and 50. In this case, if the two chosen code rates are 30 and 40, then the sum of the code rates of all windows is calculated to be 130 (40+3×30), and the calculation result exceeds the preset code rate threshold 100, so the two chosen code rates cannot be used as the preset code rate combination. If the two chosen code rates are 20 and 30, then the sum of the code rates of all windows is calculated to be 90 (30+3×20), and the calculation result is smaller than the preset code rate threshold 100, so the two chosen code rates can be used as the preset code rate combination. In this way, by choosing and calculating the code rates, two preset code rate combinations where the sum of the code rates of all windows does not exceed the preset code rate can be obtained rapidly, i.e., the preset code rate of the master window and the preset code rate of the slave window can be finally obtained.

In some exemplary embodiments, the step of determining whether the sum of the code rates of all windows is greater than the code rate threshold further includes:

taking the two chosen code rates as a usable code rate combination;

finding all usable code rate combination where the sum of code rates of all windows is not greater than the code rate threshold; and

taking one of all the usable code rate combination that has the highest sum of code rates as the preset code rate combination.

By repeating iterative calculation, all usable code rate combination where the sum of code rates of all windows is not greater than the code rate threshold can be found, and all the code rates in those usable code rate combination can enable the terminal to operate stably. Based on this, one of all the usable code rate combinations that has the highest sum of code rates is taken as the preset code rate combination. In this way, by selecting the highest code rate standard while satisfying the operating performance of the terminal, the system performance of the terminal can be utilized sufficiently, and moreover, the higher playing quality can further provide the user with better multi-window playing experiences especially for the playing effect of the master window.

Further, if there is more than one combination that has the highest sum of code rates, then one of the more than one combination which has the maximum single code rate is taken as the preset code rate combination. When there is more than one combination that has the highest sum of code rates in all usable code rate combination, one of the more than one combination which has the maximum single code rate is taken as the preset code rate combination. This is because during the process of multi-window video playing, the playing quality of the master window is paid more attention by the user and is more important to the user, and the playing quality of the master window is preset to be higher than that of the slave window, so the one of the more than one combination which has the maximum single code rate is the one combination where the code rate of the master window is the highest. In this way, the playing quality of the master window can be further improved so that the multi-window video playing not only can ensure the stable operation of the terminal, but also improves the playing effect of the master window.

In some exemplary embodiments, the playing quality further includes a size of the video playing window, and the size of the master window is greater than the size of the slave window. During the multi-window video playing, the size of the playing window is also an important factor affecting the playing quality. Usually, the size of the master window is set to be larger than the size of the slave window, or the master window may be displayed in the full screen while the slave window is suspended above the master window. In this way, the setting for the playing quality can be more accurate and reliable.

The user can adjust the size of the window in real time during the multi-window video playing process in the terminal. For example, the user can adjust the size of the window by operating the mouse on the desktop of a computer. In this way, the user can adjust the size of the video playing window in real time according to the video watching effect, thereby enabling the terminal to provide a better displaying effect.

In some exemplary embodiments, before step 102 of receiving a focus determining instruction, the method further includes the following step: determining whether the number of video playing windows changes, and if the determination result is yes, then the corresponding playing qualities are set again, and otherwise, step 102 of receiving a focus determining instruction is executed.

The change of the number of video playing windows refers to the increase or decrease of the number of the video playing windows, e.g., closing a certain playing window or adding a playing window on the playing interface of the terminal. Here, the closing of a certain playing window may also imply that the playing of the video file on this window is completed. In this way, by determining the change of the number of video playing windows in real time, the preset playing quality standard can be adjusted in time so that the multi-window video playing by the user is more stable and reliable.

In some exemplary embodiments, step 102 of receiving a focus determining instruction to determine a focus window indicated by the focus determining instruction as the master window and other windows as the at least one slave window includes:

displaying a border of the window indicated by the focus determining instruction in a highlighted and flashing way according to the focus determining instruction received; determining whether there is a new focus determining instruction within a preset time threshold; if there is, then determining the master window again according to the new focus determining instruction; and if there is not, then determining the window as the master window.

When the user is determining the master window for video playing according to the focus determining instruction, especially for the TV terminal, the user usually chooses a window by browsing windows, and if each time a window is determined as the master window immediately after it is chosen, then system resources of the terminal would be consumed greatly. Therefore, a period of time, i.e., a preset time threshold, needs to be provided for the user to make the determination. Meanwhile, by displaying the border of the chosen window in a highlighted way, the user can be prompted of the specific location of the currently chosen window. In this way, by presetting the time threshold, the efficiency and accuracy in determining the master window for video playing by the user can be greatly improved.

In some exemplary embodiments, step 103 of playing a video file in the master window according to the preset playing quality of the master window, and playing the video file in the at least one slave window according to the preset playing quality of the at least one slave window further includes: searching for a video file corresponding to the playing quality according to the preset playing quality, and obtaining the video file; and playing corresponding video files in the master window and the at least one slave windows respectively. In this way, the master window and the slave window for video playing can obtain the videos according to the preset playing qualities, thereby accurately controlling the multi-window video playing and finally ensuring the smoothness in video playing on the terminal.

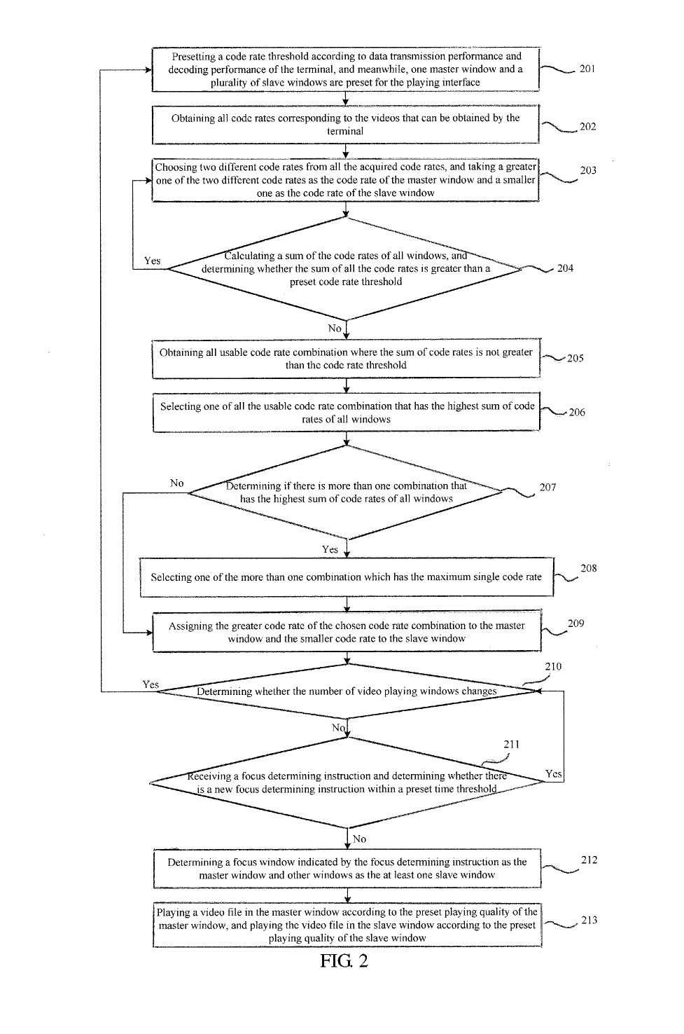

FIG. 2 is a flowchart diagram of another embodiment of a method for playing quality adjustment in multi-window video playing according to the present disclosure. The method for playing quality adjustment in multi-window video playing includes the following steps.

In Step 201: presetting a maximum code rate threshold that the terminal is able to withstand according to data transmission performance and decoding performance of the terminal. Meanwhile, the number of playing windows is preset for the video playing interface so that one master window and at least one slave window are included.

In Step 202: obtaining all video files that can be obtained by the terminal, and obtaining code rates corresponding to the video files.

In Step 203: choosing two different code rates from all the obtained code rates, and taking a greater one of the two different code rates as the code rate of the master window and a smaller one as the code rate of the slave window.

In Step 204: calculating a sum of the code rates of all windows according to the number of the master window and the slave windows, and determining whether the sum of all the code rates is greater than a preset code rate threshold. If the determination result is yes, then return to step 203 to re-choose two different code rates and, otherwise, the two different code rates are used as a usable code rate combination to execute step 205.

In Step 205: executing step 203 and step 204 repeatedly, and obtaining all usable code rate combination where the sum of code rates is not greater than the preset code rate threshold through iterative calculation.

In Step 206: selecting one of all the usable code rate combination that has the highest sum of code rates.

In Step 207: determining if there is more than one combination that has the highest sum of code rates, and if the determination result is yes, then step 208 is executed, and otherwise, step 209 is executed.

In Step 208: if there is more than one combination that has the highest sum of code rates according to step 207, selecting one of the more than one combination which has the maximum single code rate.

In Step 209: according to step 207 or step 208, assigning the greater code rate of the chosen code rate combination to the master window and the smaller code rate to the slave window.

In Step 210: determining whether the number of video playing windows changes, and if the determination result is yes, then returning to step 201, and otherwise, executing step 211.

In Step 211: if the number of video playing windows does not change according to step 210, receiving a focus determining instruction and determining whether there is a new focus determining instruction within a preset time threshold, and if the determination result is yes, then returning to step 210, and otherwise, executing step 212.

In Step 212: according to step 211, determining a focus window indicated by the focus determining instruction as the master window and other windows as the at least one slave window according to the focus determining instruction.

In Step 213: according to the master window and the slave window chosen in step 212, playing a video file in the master window according to the preset code rate of the master window, and playing the video file in the at least one slave window according to the preset code rate of the at least one slave window.

In this way, the terminal can utilize the performance thereof sufficiently, and by adjusting the code rates of the videos, the stability and smoothness of multi-window video playing are ensured.

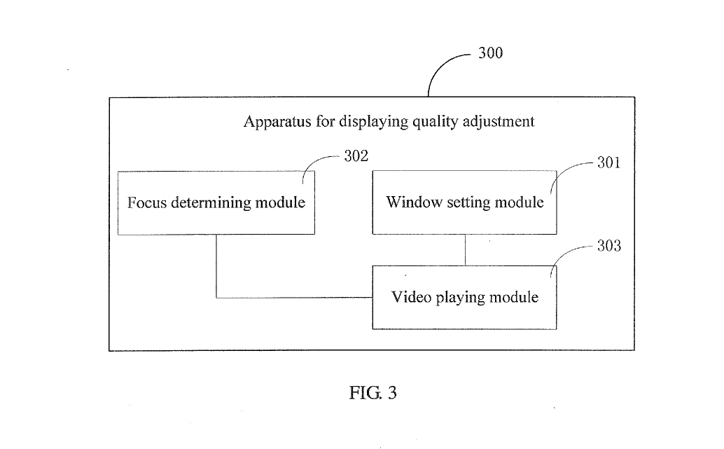

FIG. 3 is a schematic structural diagram of an embodiment of an apparatus 300 for playing quality adjustment in multi-window video playing according to the present disclosure. The apparatus 300 for playing quality adjustment in multi-window video playing includes a window setting module 301, a focus determining module 302, and a video playing module 303.

The window setting module 301 is configured to preset the number of video playing windows and corresponding playing qualities according to performance of a terminal, wherein the video playing windows include one master window and at least one slave window; and all of the at least one slave window are set to have the same playing quality, and the master window has a playing quality higher than that of the at least one slave window;

The focus determining module 302 is configured to receive a focus determining instruction to determine a focus window indicated by the focus determining instruction as the master window and other windows as the at least one slave window, and instruct the video playing module 303 to play the video; and

The video playing module 303 is configured to receive the instruction sent by the focus determining module 302 and play a video file in the master window according to the preset playing quality of the master window, and play the video file in the at least one slave window according to the preset playing quality of the at least one slave window that are preset in the window setting module 301.

As can be known from the above embodiments, the apparatus 300 for playing quality adjustment in multi-window video playing uses the window setting module 301 to preset the number of video playing windows and corresponding playing qualities, uses the focus determining module 302 to determine the master window for video playing, and finally uses the video playing module 303 to play the video according to the preset playing quality, thereby ensuring the smoothness in multi-window video playing on the terminal.

In some exemplary embodiments, the playing quality includes a code rate of the video; and the higher the code rate of the video is, the higher the playing quality of the video will be.

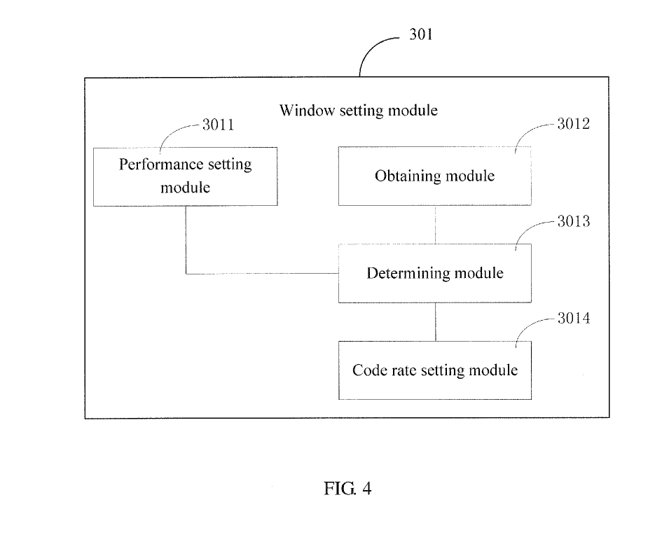

As shown in FIG. 4, the window setting module 301 includes:

a performance setting module 3011, configured to preset a maximum code rate threshold that the terminal is able to withstand according to data transmission performance and decoding performance of the terminal; and

a code rate setting module 3014, configured to set a code rate of the master window and a code rate of the at least one slave window according to the number of video playing windows preset by the performance setting module 3011 in such a way that the sum of the code rates of all the video playing windows does not exceed the code rate threshold.

In this way, the apparatus 300 for playing quality adjustment in multi-window video playing can adjust the multi-window video playing quality by adjusting the code rates of the videos, thereby providing a better multi-window playing effect.

In some exemplary embodiments, the window setting module 301 further includes:

an obtaining module 3012, configured to obtain all code rates corresponding to videos that can be obtained by the terminal, choose two different code rates from all the code rates, and take a greater one of the two different code rates as the code rate of the master window and a smaller one as the code rate of the slave window;

a determining module 3013, configured to calculate a sum of the code rates of the master window and all the at least one slave window according to the code rates chosen by the obtaining module 3012, and determine whether the sum of all the code rates is greater than the code rate threshold, and if the determination result is yes, then the obtaining module 3012 is instructed to re-choose two different code rates to make the determination and, otherwise, the code rate setting module 3014 is instructed to use the two different code rates as a preset code rate combination to assign the greater one of the two different code rates to the master window and the smaller one to the at least one slave window.

In this way, the apparatus 300 uses the determining module 3013 to further determine the code rates so that two suitable code rates are chosen from the code rates obtained by the obtaining module 3012 to serve as the preset code rate of the master window and the preset code rate of the slave window.

In some exemplary embodiments, the determining module 3013 is further configured to take the two chosen code rates as a usable code rate combination; find all usable code rate combination where the sum of code rates is not greater than the code rate threshold; and select one of all the usable code rate combination that has the highest sum of code rates and instruct the code rate setting module 3014 to use the code rate combination as the preset code rate combination. Among all usable code rate combination where the sum of code rates is not greater than the code rate threshold, one combination that has the highest sum of code rates is chosen as the preset code rate combination. In this way, the performance of the terminal can be utilized sufficiently to maximize the use of performance control. That is, a better playing effect can be provided for the user while the videos are played stably.

In some exemplary embodiments, the determining module 3013 is further configured to determine if there is more than one combination that has the highest sum of code rates of all windows, and if the determination result is yes, then select one of the more than one combination which has the maximum single code rate and instruct the code rate setting module 3014 to use the code rate combination as the preset code rate combination. In this way, the terminal can obtain a unique preset code rate combination, thereby ensuring the stable operation of the apparatus.

In some exemplary embodiments, the focus determining module 302 is further configured to determine whether the number of video playing windows changes, and instruct the window setting module 301 to set the corresponding playing qualities again if the determination result is yes, and otherwise, receive the focus determining instruction. In this way, the focus determining module 302 determines the number of video playing windows to ensure the validity of the video code rates that are preset previously, thereby ensuring the accuracy and reliability of the apparatus 300 for playing quality adjustment in multi-window video playing.

In some exemplary embodiments, the focus determining module 302 is further configured to display a border of the window indicated by the focus determining instruction in a highlighted and flashing way according to the focus determining instruction received; determine whether there is a new focus determining instruction within a preset time threshold; and if there is, then determine the master window again according to the new focus determining instruction. In this way, by presetting a time threshold, the focus determining module 302 gives the user a period of time for the user to determine the master window for video playing, and thus the speed and efficiency in determining the master window for video playing can be greatly improved. Meanwhile, displaying the border of the window in a highlighted and flashing way enables the user to know clearly the location of the window currently chosen.

In some exemplary embodiments, the video playing module 303 is further configured to search for a video file corresponding to the playing quality according to the preset playing quality, obtain the video file, and play corresponding video files in the master window and the at least one slave windows respectively. In this way, the video playing module 303 obtains the corresponding video file according to the preset playing quality, thereby achieving the reliable operation of multi-window video playing.

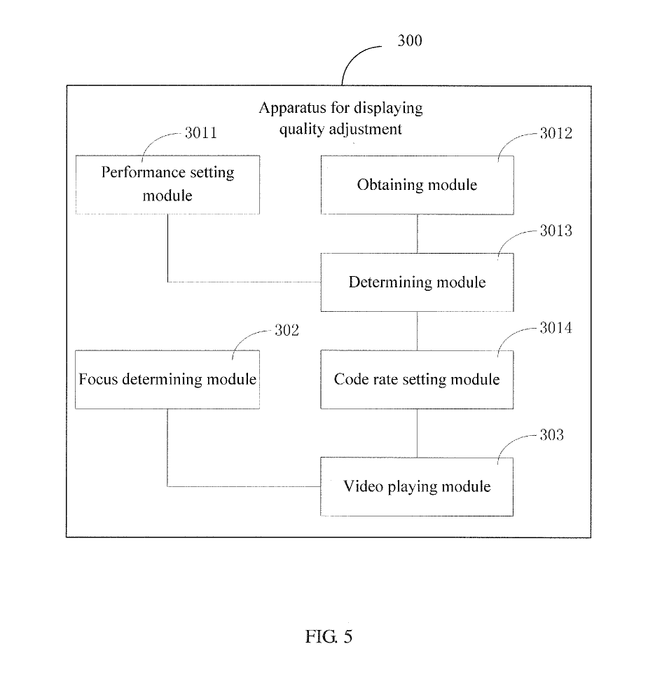

FIG. 5 is a schematic structural diagram of another embodiment of the apparatus 300 for playing quality adjustment in multi-window video playing according to the present disclosure. The apparatus 300 for playing quality adjustment in multi-window video playing includes: a performance setting module 3011, an obtaining module 3012, a determining module 3013, a code rate setting module 3014, a focus determining module 302, and a video playing module 303. Each of the performance setting module 3011 and the obtaining module 3012 is connected to the determining module 3013, the determining module 3013 is connected to the code rate setting module 3014, and both the code rate setting module 3014 and the focus determining module 302 are connected to the video playing module 303. The determining module 3013 determines and chooses two code rates where the sum of code rates of all windows is not greater than the preset code rate threshold according to the code rates obtained by the obtaining module 3012 and the code rate threshold preset by the performance setting module 3011, and then uses the two code rates respectively as the preset code rate of the master window and the preset code rate of the slave window. The video playing module 303 determines the master window for video playing according to the focus indicated by the focus determining module 302, and then plays the corresponding video files in the master window and the slave window respectively according to the preset code rate of the master window and the preset code rate of the slave window that are chosen by the determining module 3013, thereby achieving the adjustment for the playing quality of multi-window video playing and providing the users with better displaying experiences.

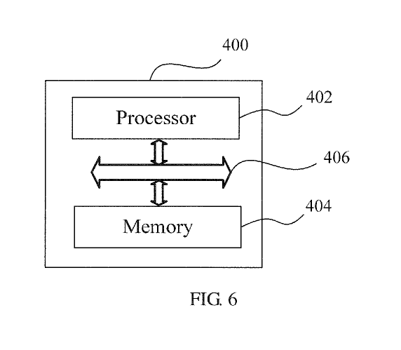

FIG. 5 is a schematic structural diagram of an embodiment of a video playing terminal 400 according to the present disclosure. As shown in FIG. 6, the video playing terminal 400 includes at least one processor 402, a memory 404, and a bus system 406. The at least one processor 402 and the memory 404 are connected with each other via the bus system 406, the memory 404 is configured to store instructions, and the at least one processor 402 is caused to execute instructions stored in the memory 404.

The memory 404 may be a non-transitory computer readable storage medium for storing computer executable instructions which, when being executed by one or more processors 402, enable the processor 402 to execute steps S101 to S103 of the method described above in FIG. 1 or steps S201 to S213 of the method described above in FIG. 2. The computer executable instructions may also be stored and/or transmitted in any non-transitory computer readable storage medium for use in an instruction execution system, apparatus or device or for use in combination with an instruction execution system, apparatus or device. The instruction execution system, apparatus or device is, for example, a computer-based system, a system including a processor, or some other systems that can obtain instructions from the instruction execution system, apparatus or device and execute the instructions. For purpose of this document, the “non-transitory computer readable storage medium” may be any tangible medium that contains or stores computer executable instructions which may be used by or in combination with the instruction execution system, apparatus or device. The non-transitory computer readable storage medium may include but is not limited to magnetic, optical and/or semiconductor storage devices. Examples of these storage devices include magnetic disks, optical disks based on CD, DVD or Blu-ray technologies, and persistent solid-state storages (e.g., flash memories, solid-state drives and etc).

In some exemplary embodiments, the apparatus 300 in FIGS. 3-5 described above is a computer software program apparatus, and the modules 301 to 303 and the modules 3011 to 3014 are computer software program modules stored in the memory 404. In operation, the modules 301 to 303 and the modules 3011 to 3014 are executed by the processor 402 to accomplish functions of each of the modules.

It shall be understood that, in the embodiments, the processor 402 may be a central processing unit (CPU). The processor 404 may also be some other general-purpose processor, digital signal processor (DSP), application specific integrated circuit (ASIC), field programmable gate array (FPGA) or some other programmable logic element, discrete gate or transistor logic element, discrete hardware component and etc. The general-purpose processor may be a microprocessor or may be any common processor.

In addition to data buses, the bus system 406 may also include power supply buses, control buses, state signal buses and so on. However, for clarity of description, all kinds of buses are labeled as the bus system 406 in the attached drawings.

In the embodiments of the present disclosure, parts and arrangement of the video playing terminal 400 are not limited to what shown in FIG. 6, but may also include other or additional parts in various arrangements.

During the implementation, the steps of the method or modules of the apparatus described above may be implemented by integrated logic circuits in hardware form or instructions in software form in the processor 402. The steps of the methods or modules of the apparatus disclosed in the embodiments of this application may be directly embodied as hardware processors, or by a combination of hardware modules and software modules in the processor 402. The software modules may reside in a storage medium well-known in the art such as a random access memory (RAM), a flash memory, a read only memory (ROM), a programmable ROM, an electrically erasable programmable memory, or a register. The storage medium resides in the memory 404, and information stored in the memory 404 is read by the processor 402 to accomplish the steps of the method described above via hardware of the processor 402. This will not be detailed herein for purpose of simplicity.

As shall be appreciated by those of ordinary skill in the art, the above discussion of any embodiments is only illustrative and is not intended to imply that the scope (including the claims) of the present disclosure is limited to these examples; and within the spirits of the present disclosure, technical features of the above embodiments or different embodiments may be combined with each other, the steps may be achieved in any sequence, and there are many other variations in different aspects of the present disclosure described above, although they are not detailed for purpose of simplicity.

Accordingly, any omissions, modifications, equivalent replacements, and alterations within the spirits and principles of the present disclosure shall be included in the scope of the present disclosure.

What is claimed is:

1. A method for playing quality adjustment in multi-window video playing, the method comprising:
at an electronic device;
presetting the number of video playing windows and corresponding playing qualities according to performance of the electronic device, wherein the video playing windows comprises one master window and at least one slave window; and all of the at least one slave window are set to have the same playing quality, and the master window has a playing quality higher than that of the at least one slave window;
receiving a focus determining instruction to determine a focus window indicated by the focus determining instruction as the master window and other windows as the at least one slave window; and
playing a video file in the master window according to the preset playing quality of the master window, and playing the video file in the at least one slave window according to the preset playing quality of the at least one slave window.

2. The method according to claim 1, wherein the playing qualities comprise a code rate of the video, and presetting the number of video playing windows and corresponding playing qualities according to performance of the electronic device comprises:
presetting a maximum code rate threshold that the electronic device is capable of withstanding according to data transmission performance and decoding performance of the electronic device; and
setting a code rate of the master window and a code rate of the at least one slave window according to the preset number of video playing windows in such a way that the sum of the code rates of all the video playing windows does not exceed the code rate threshold.

3. The method according to claim 2, wherein setting a code rate of the master window and a code rate of the at least one slave window according to the preset number of video playing windows comprises:
obtaining all code rates corresponding to videos that is capable of being obtained by the electronic device;
choosing two different code rates from all the code rates;
taking a greater one of the two different code rates as the code rate of the master window and a smaller one as the code rate of the slave window;
calculating a sum of the code rates of the master window and all the at least one slave window;
determining whether the sum of the code rates of all windows is greater than the code rate threshold;
regarding the two different code rates as a preset code rate combination if the sum of the code rates of all windows is not greater than the code rate threshold; and
assigning the greater one of the two different code rates to the master window and the smaller one to the at least one slave window; and
re-choosing two different code rates to make the determination if the sum of the code rates of all windows is greater than the code rate threshold.

4. The method according to claim 2, wherein determining whether the sum of the code rates of all windows is greater than the code rate threshold comprises:
taking the two chosen code rates as a usable code rate combination;
finding all usable code rate combination where the sum of code rates of all windows is not greater than the code rate threshold; and
taking one of all the usable code rate combination that has the highest sum of code rates as the preset code rate combination.

5. The method according to claim 4, wherein taking one of all the usable code rate combination that has the highest sum of code rates comprises:
taking one of the more than one combination which has the maximum single code rate as the preset code rate combination if there is more than one combination that has the highest sum of code rates.

6. The method according to claim 1, wherein the playing qualities comprise: a size of the video playing window, and the size of the master window is greater than the size of the slave window.

7. The method according to claim 1, wherein before receiving a focus determining instruction, the method further comprises:
determining whether the number of video playing windows changes;
receiving a focus determining instruction if the number of video playing windows does not change; and
setting the corresponding playing qualities if the number of video playing windows changes.

8. The method according to claim 1, wherein receiving a focus determining instruction to determine a focus window indicated by the focus determining instruction as the master window and other windows as the at least one slave window comprises:
displaying a border of the window indicated by the focus determining instruction in a highlighted and flashing way according to the focus determining instruction received;
determining whether there is a new focus determining instruction within a preset time threshold; and
regarding the window as the master window if whether there is no a new focus determining instruction within a preset time threshold.

9. The method according to claim 1, wherein playing a video file in the master window according to the preset playing quality of the master window, and playing the video file in the at least one slave window according to the preset playing quality of the at least one slave window comprises:
searching for a video file corresponding to the playing quality according to the preset playing quality;
obtaining the video file; and
playing corresponding video files in the master window and the at least one slave windows respectively.

10. An electronic device, comprising:
at least one processor; and
a memory communicably connected with the at least one processor for storing instructions executable by the at least one processor, wherein execution of the instructions by the at least one processor causes the at least one processor to:
preset the number of video playing windows and corresponding playing qualities according to performance of the electronic device, wherein the video playing windows comprises one master window and at least one slave window; and all of the at least one slave window are set to have the same playing quality, and the master window has a playing quality higher than that of the at least one slave window:
receive a focus determining instruction to determine a focus window indicated by the focus determining instruction as the master window and other windows as the at least one slave window; and
play a video file in the master window according to the preset playing quality of the master window, and play the video file in the at least one slave window according to the preset playing quality of the at least one slave window.

11. The electronic device according to claim 10, wherein the playing qualities comprise a code rate of the video, and presetting the number of video playing windows and corresponding playing qualities according to performance of the electronic device comprises:
presetting a maximum code rate threshold that the electronic device is capable of withstanding according to data transmission performance and decoding performance of the electronic device; and
setting a code rate of the master window and a code rate of the at least one slave window according to the preset number of video playing windows in such a way that the sum of the code rates of all the video playing windows does not exceed the code rate threshold.

12. The electronic device according to claim 11, wherein setting a code rate of the master window and a code rate of the at least one slave window according to the preset number of video playing windows comprises:
obtaining all code rates corresponding to videos that is capable of being obtained by the electronic device;
choosing two different code rates from all the code rates;
taking a greater one of the two different code rates as the code rate of the master window and a smaller one as the code rate of the slave window;
calculating a sum of the code rates of the master window and all the at least one slave window;
determining whether the sum of the code rates of all windows is greater than the code rate threshold;
regarding the two different code rates as a preset code rate combination if the sum of the code rates of all windows is not greater than the code rate threshold;
assigning the greater one of the two different code rates to the master window and the smaller one to the at least one slave window; and
re-choosing two different code rates to make the determination if the sum of the code rates of all windows is greater than the code rate threshold.

13. The electronic device according to claim 11, wherein determining whether the sum of the code rates of all windows is greater than the code rate threshold comprises:
taking the two chosen code rates as a usable code rate combination;
finding all usable code rate combination where the sum of code rates of all windows is not greater than the code rate threshold; and
taking one of all the usable code rate combination that has the highest sum of code rates as the preset code rate combination.

14. The electronic device according to claim 13, wherein taking one of all the usable code rate combination that has the highest sum of code rates comprises:
taking one of the more than one combination which has the maximum single code rate as the preset code rate combination if there is more than one combination that has the highest sum of code rates.

15. The electronic device according to claim 10, wherein the playing qualities comprise: a size of the video playing window, and the size of the master window is greater than the size of the slave window.

16. The electronic device according to claim 10, wherein before receiving a focus determining instruction, execution of the instructions by the at least one processor further causes the at least one processor to:
determine whether the number of video playing windows changes;
receive a focus determining instruction if the number of video playing windows does not change and
set the corresponding playing qualities if the number of video playing windows changes.

17. The electronic device according to claim 10, wherein receiving a focus determining instruction to determine a focus window indicated by the focus determining instruction as the master window and other windows as the at least one slave window comprises:
displaying a border of the window indicated by the focus determining instruction in a highlighted and flashing way according to the focus determining instruction received;
determining whether there is a new focus determining instruction within a preset time threshold; and
regarding the window as the master window if whether there is no a new focus determining instruction within a preset time threshold.

18. The electronic device according to claim 10, wherein playing a video file in the master window according to the preset playing quality of the master window, and playing the video file in the at least one slave window according to the preset playing quality of the at least one slave window comprises:
searching for a video file corresponding to the playing quality according to the preset playing quality;
obtaining the video file; and
playing corresponding video files in the master window and the at least one slave windows respectively.

19. A non-transitory computer-readable storage medium storing executable instructions, wherein when executed by an electronic device, causes the electronic device to:
preset the number of video playing windows and corresponding playing qualities according to performance of the electronic device, wherein the video playing windows comprises one master window and at least one slave window; and all of the at least one slave window are set to have the same playing quality, and the master window has a playing quality higher than that of the at least one slave window;
receive a focus determining instruction to determine a focus window indicated by the focus determining instruction as the master window and other windows as the at least one slave window; and
play a video file in the master window according to the preset playing quality of the master window, and play the video file in the at least one slave window according to the preset playing quality of the at least one slave window.

20. The non-transitory computer-readable storage medium according to claim 19, wherein the playing qualities comprise a code rate of the video, and presetting the number of video playing windows and corresponding playing qualities according to performance of the electronic device comprises:
presetting a maximum code rate threshold that the electronic device is capable of withstanding according to data transmission performance and decoding performance of the electronic device; and
setting a code rate of the master window and a code rate of the at least one slave window according to the preset number of video playing windows in such a way that the sum of the code rates of all the video playing windows does not exceed the code rate threshold.
